(19) United States
(12) Patent Application Publication
(10) Pub. No.: US 2011/0278769 A1
(43) Pub. Date: Nov. 17, 2011

(54) MOULD AND METHOD FOR PRODUCING MULTI-LAYER SHAPED PARTS OF PLASTIC

(75) Inventors: Hubert Ehbing, Odenthal (DE); Dirk Bruening, Leverkusen (DE); Rainer Protte, Dormagen (DE)

(73) Assignee: Bayer MaterialScience AG, Leverkusen (DE)

(21) Appl. No.: 13/145,616

(22) PCT Filed: Jan. 13, 2010
(86) PCT No.: PCT/EP2010/000127

§ 371 Date: Jul. 21, 2011

(30) Foreign Application Priority Data
Jan. 21, 2009 (DE) 10 2009 005 609.2

(51) Int. Cl. B29C 45/14; B28B 7/36

(52) U.S. Cl. 264/446; 425/89

(57) ABSTRACT

The invention relates to a mould for producing multilayer plastics mouldings composed of at least two mould halves and of a cavity within which plastic is received, and of a feed system with a feed channel, and also to a process for producing multilayer plastics mouldings.

The invention relates to a mould for producing multilayer plastics mouldings composed of at least two mould halves, a cavity within which plastic is received, and a feed system with a feed channel; and also relates to a process for producing multilayer plastics mouldings.

The prior art discloses the production of multilayer plastics mouldings. EP 197 496 B describes a process in which a substrate is injected between two separable mould halves. As soon as the substrate has cured sufficiently, a covering is injected with a pressure substantially above the mould-cavity pressure and is forced across the entire surface or across regions of the surface of the substrate.

DE 43 16 154 C describes a process for the visible-side coating of a component. In the process, the uncoated component is placed in a mould similar to an injection mould and then a resin or a coating is applied to the visible surface with the use of pressure and heat. During the entire hardening time, a pressure is exerted on the resin as it sets, or on the coating, and is constant over time, and has been selected in such a way that any air present remains dissolved in the liquid resin or coating.

EP 934 808 A discloses a process for coating in a mould by, in a first step, producing a moulding made of a synthetic resin, for example by an injection moulding process. This is achieved via application of a clamping pressure to a mould, which has one fixed and one moveable mould half. In a second step, the clamping pressure is reduced or the fixed and the moveable mould half are separated. A coating composition is then injected into the mould, between an inner surface and the surface of the moulding. The coating composition hardens with use of a specific pressure profile.

WO 2006/072366 A discloses a process for moulding and coating a substrate in a mould with at least two cavities, where a substrate is first moulded in a cavity within a mould, preferably by an injection moulding process. The resultant substrate is then introduced into a second cavity of the mould and is coated with a coating under pressure in a further step.

The processes described above preferably use reactive resin systems or reactive coating systems for coating, and these must adhere well to the substrates. The surface of the coating preferably replicates the shape of a metallic mould, and in order to provide good demouldability there should be no adhesion of the coating to the metallic mould. The prior art, therefore, often applies external release agents to that internal surface of the cavity, the shape of which is replicated on the surface, and/or adds internal release agents to the coating material, and/or uses a permanent release coating on the internal surface of the cavity. This is particularly necessary for that region of the mould that is near to the gate by way of which the coating material is injected into the cavity. At this location there are high pressures and shear forces present during the injection procedure, and these cause rapid ablation of the external release agents introduced, with rapid loss of release effect at the said location.

External release agent systems are known by way of example in the form of solutions or dispersions which are usually sprayed onto the surface of the mould. Release agent systems of this type are composed of active ingredients that have release effect (for example wax) and of a carrier medium, generally organic solvents or water. The use of external release agents is disclosed by way of example in DE 1 131 873 A and DE 38 27 595 C.

It is frequently necessary to introduce external release agents into the cavity prior to every step of moulding production. This incurs production costs and slows the production process. Furthermore, the release agents can affect the properties of the mouldings and residues remaining on the surface can cause difficulties in subsequent steps of processing (lacquering, coating, lamination, etc.). The solvents can moreover escape from the release agents into the environment and endanger the health of production workers.

One particular disadvantage with the use of external release agents in particular in the region of the gate for forming the coating layer is that the injection procedure ablates the external release agents and transports them to the interface between backing substrate and coating. This results in poor adhesion between the substrate and the coating.

Additionally, or as an alternative, it is possible to add internal release agents to the components of the coating system. This type of procedure is described by way of example in DE 38 37 351 C, which adds liquid polybutadiene to the polyol component or the polyamine component during production of polyurethane products or polyurea products. Other descriptions of the said procedure are found in “Innere Trennmittel für Polyurethan-Systeme” [Internal release agents for polyurethane systems], P. Horn, H.-U. Schmidt and G. Ramlow, Kunststoffberater 10/1987, pp. 24-26 and in “Kunststoffhandbuch 7. Polyurethane” [Plastics handbook 7—Polyurethanes], edited by Günter Oertel, 3rd revised edition, 1993, p. 370, Hanser-Verlag.

A disadvantage of internal release agents is that they can also exert their release effect in relation to the substrate that is to be coated. Good release effect with respect to the mould is then attended by poor adhesion with respect to the substrate. Furthermore, the internal release agents can considerably influence the properties of the coating and therefore those of the component. Subsequent diffusion out of the material to the surface cannot always be prevented, and has adverse consequences for the component (optical properties, feel, emissions from the component).

The prior art also uses permanent mould coatings, as well as internal and external release agents. EP 0 841 140 A and DE 100 34 737 A describe processes for improving the release of the moulding from the mould by reducing the surface energy through plasma coating. These layers have to be adjusted in such a way that the coating systems do not enter into any further chemical reactions with the surface. However, release layers of this type do not have adequate mechanical stability and lead to short operating times. Frequent and therefore expensive renewal of the coating is required. For this, the mould has to be removed from the production process, and there is therefore also a relatively long production stoppage.

The prior art describes not only plasma coatings but also nickel coatings and chromium coatings. “Kunststoffhandbuch 7. Polyurethane” [Plastics handbook 7—Polyurethanes], edited by Günter Oertel, 3rd revised edition, 1993, pp. 362-363, Hanser-Verlag discloses a process of chemical nickel coating or other hard coating of moulds to improve their surface quality.

EP 0 973 960 B discloses a process for producing a foam moulding in a mould of which the moulding surfaces have an anti-adhesive coating based on chromium in the form of an electroplated layer. An ionized gas or a gas mixture is also injected into the mould.

A disadvantage with the permanent anti-adhesive coatings is that their effect is inadequate for polyurethane systems, the anti-adhesive effect is rapidly lost particularly if damage occurs, and renewal of the anti-adhesive layer implies considerable cost in conjunction with a relatively long production stoppage.

The prior art also discloses processes in which removable mould inserts are used. EP 1 320 451 B describes a process for producing mouldings with the aid of removable mould parts and of at least one removable elastic liner placed across the removable mould parts. The elastic liner serves to avoid any appearance of lines on the moulding, caused by the removable mould parts. A disadvantage is that whenever a moulding is demoulded the elastic liner is concomitantly demoulded and in turn has to be reinserted. Again, this implies increased operating cost.

The company Cannon, in Trezzano, Italy markets a technology called “Film & Foam” (http://www.thecannongroup.com/default.asp), in which a thin separator foil is inserted into the mould prior to production of the moulding. The said foil has been subjected to a thermoforming process in the mould to match it to the shape of the surface of the moulding and it replaces the release agent. Disadvantages of the said process are that the properties of the foil restrict structuring of the surface, no undercuts are possible, the insertion and thermoforming of the foil requires additional operations, and after a certain time the separator foil has to be discarded as waste.

It was therefore an object of the present invention to provide a mould and a process which do not have the abovementioned disadvantages.

Surprisingly, the said object is achieved by using, instead of the moulds used hitherto, a mould with removable separator inserts. The shape of the surfaces of the inserts is the same as that of the mould, and they are inserted with precise fit, preferably with use of instant-fixing devices (e.g. using pneumatic or magnetic devices).

The invention provides a mould for producing multilayer plastics mouldings composed of at least two mould halves and of a cavity within which plastic is received, and of a feed system with a feed channel and
a) with a replaceable mould-release insert either with an external means of separation or without an external means of separation or
b) with a replaceable mould-release insert with a permanent or semi-permanent separating layer or
c) with a replaceable mould-release insert composed of a permanently separating material (e.g. Teflon).

The invention further provides a process for producing multilayer plastics mouldings encompassing the following steps:
i) moulding a substrate in a first cavity of a mould,
ii) forming a second cavity, by introducing the substrate produced in i) into a second mould or by introducing one mould half of the mould together with the substrate produced in i) into a second mould, or by producing a second cavity on the surface of the substrate through a partial mould opening,
iii) in the second cavity, coating of the substrate produced according to i) with a coating or with a plastic or with a reaction mixture for producing a coating or for producing a plastic, where the coating or the plastic or the reaction mixture for producing a coating or for producing a plastic is introduced by way of a feed system with a feed channel and with a replaceable mould-release insert,
iv) demoulding the moulding produced in iii) and optionally removing the projecting regions of the moulding,
v) replacing the mould-release insert if the separation provided by the insert has become less effective due to wear or damage.

The generic term coating or coating system is used below to refer to the coating, the plastic and the reaction mixture for producing a coating or a plastic.

The moulding of the substrate in step i) preferably takes place by means of injection moulding technology, through injection moulding, injection-compression moulding, compression moulding, foaming or reaction injection moulding. The coating of the substrate in step iii) preferably takes place by means of reaction injection moulding (RIM) processes, in particular with use of coatings (e.g. two-component reaction mixtures), for example those based on aromatic polyurethane systems, polyurea systems or aliphatic polyurethane systems.

The advantages of the mould according to the invention and of the process according to the invention are inter alia that it is possible to use mould inserts with good release properties at the locations that are critical in respect of the release of the moulding from the mould. This applies to the region close to the gate but also to overflow channels, and sealing edges and to the shaping surface of the moulds or portions of the same. Mould inserts are moreover less expensive, and it is therefore only the mould-release insert that has to be replaced when release effect is lost or damage occurs, with no need to replace or repair the entire mould. The availability time of the mould increases markedly.

It is also possible to use a plurality of mould inserts in parallel. A release layer can be applied outside the mould. When release effect is lost, a freshly coated insert is used to replace an old, worn insert.

Introduction of the insert into the mould can by way of example be achieved by means of a robot in conjunction with an appropriate adaptor system. An adaptor system can comprise an instant-coupling system which by of example uses subatmospheric pressure or an electrical magnet to fix the mould insert within the mould. For changeover of the insert, the magnet or the subatmospheric pressure is switched off, and the insert can easily be removed.

The mould can also have a device for measuring demoulding force. Coupled to the measuring device for the demoulding force, there is a mechanism which, as soon as increased demoulding force is detected, triggers a mechanism which automatically replaces the mould-release insert with a fresh insert.

A suitable material for the mould-release insert is any of the materials which have the necessary surface quality and the necessary strength. Steel and corresponding alloys are particularly suitable.

In one preferred embodiment, the mould-release insert forms the feed system for injection of the coating, or forms that portion of the feed system that is directly adjacent to the cavity for the coating. This has the advantage that the said region can be kept free from external release agent, so that no release agent is entrained by the flow of the coating into the mould on injection of the coating, thus passing into the boundary layer between substrate and coating. In this instance, the requirements placed upon the mould-release insert with respect to surface quality and to strength are less stringent.

Suitable release coating materials on the mould-release insert are any of the materials and coatings which have adequate release effect in relation to the coating system used and which provide adequate operating time.

In particular, the permanent release layers known from the prior art for coating systems, in particular PU systems, can be used.

It is also possible to apply semipermanent release coatings to the mould-release inserts. Examples of suitable materials are reactive and solvent-containing silicone polymer systems, applied by means of spraying, dip-coating or spreading processes to the mould-release insert. When release effect is lost, the mould-release insert can easily be cleaned again and recoated. Systems of this type are marketed inter alia with trade name Renodiv by the company Rhein Chemie Rheinau GmbH, Mannheim.

Other examples of materials that can be applied are permanent chromium-nickel coatings, chromium coatings, nickel coatings, nickel fluoride coatings and polymeric coatings. Graduated layers and layers having a plurality of sublayers can be used in particular to improve operating time. Suitable coating processes are inter alia chemical processes, electroplating process, vacuum-based coating processes (e.g. physical vapour deposition coating processes) and plasma coating processes.

It is also possible to use mould-release inserts or a surface layer of these made of materials with low surface tension. By way of example, fluoropolymers (e.g. Teflon) or polyolefins (e.g. polyethylene, polypropylene) can be used.

In another embodiment, a thin foil or a lamella is used as mould-release insert by way of example in the feed system, at the parting line or as a portion of overflow channels. The insert material does not require any material-specific release properties, because the insert is inserted immediately prior to production of a moulding, e.g. by using a robot, and is demoulded with the moulding. The mould-release insert with the sprue adhering thereto or with the overflow of coating is separated from the actual moulding and could optionally be reused after appropriate treatment.

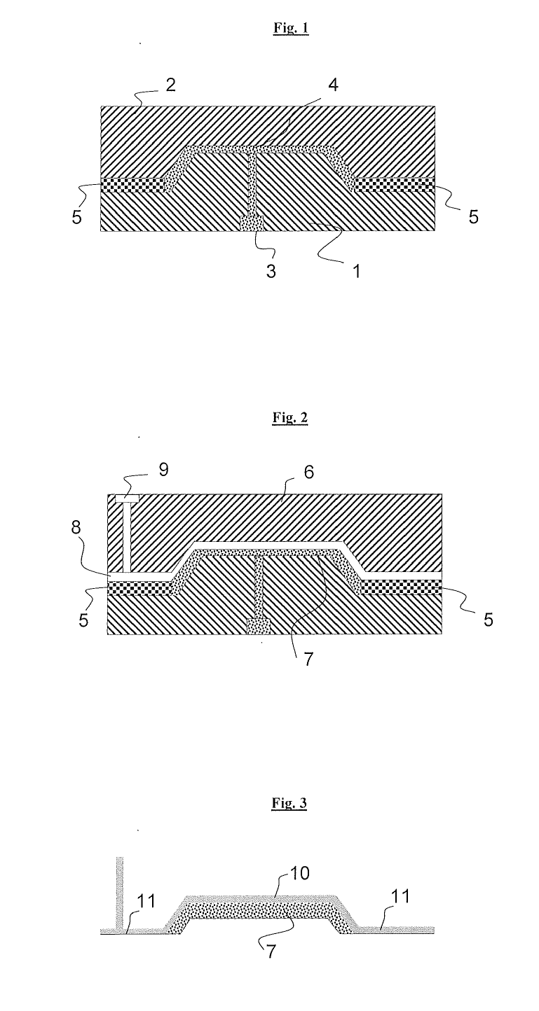

The invention will be explained in more detail by using the figures below. FIGS. 1 to 3 show the principles involved in the sequence of the process. FIG. 1 shows an injection mould for producing the substrate composed of a first mould half (1) and of a second mould half (2). The substrate is injected into the substrate cavity (4) by way of the feed channel (3). At the side of the substrate cavity there are the mould-release inserts (5).

Once the substrate has achieved adequate strength, the second mould half (2) is replaced by a third mould half (6), (FIG. 2). The third mould half (6), the mould-release inserts (5) and the solidified substrate (7) then form the cavity (8) for the coating. External release agent must if appropriate be applied to the interior surface of the mould half (6), but the mould-release insert requires no such application. The coating is charged by way of the feed system (9) to the cavity for the coating layer (8).

Once the coating has hardened, the coated component (moulding) shown in FIG. 3 can be demoulded. The moulding is composed of the substrate material (7), the coating (10) and lateral projections (11) which are separated from the moulding after demoulding.

1-9. (canceled)

10. A mould for producing multilayer plastics mouldings, comprising:
at least two mould halves;
a cavity within which plastic is received;
a feed system with a feed channel; and
a replaceable mould-release insert
a) with either an external means of separation or without an external means of separation, or
b) a permanent or a semi-permanent separating layer, or
c) a permanently separating material.

11. The mould according to claim 1, wherein the mould-release insert has been coated with a semi-permanent reactive silicone polymer.

12. The mould according to claim 1, wherein the mould-release insert forms the feed system, the parting line, overflow chambers or portions thereof.

13. The mould according to claim 10, wherein the mould-release insert is held by means of a pneumatic or magnetic device within the mould.

14. A process for producing multilayer plastics mouldings, comprising the following steps:
i) moulding a substrate in a first cavity of a mould;
ii) forming a second cavity, by introducing the substrate produced in i) into a second mould or by introducing one mould half of the mould together with the substrate produced in i) into a second mould, or by producing a second cavity on the surface of the substrate through a partial mould opening;
iii) in the second cavity, coating the substrate produced according to i) with a coating or a plastic or a reaction mixture, wherein the reaction mixture produces a coating or produces a plastic, wherein the coating or the plastic or the reaction mixture is introduced by way of a feed system with a feed channel and with a replaceable mould-release insert;
iv) demoulding the moulding produced in iii) and optionally removing the projecting regions of the moulding; and
v) replacing the mould-release insert, if the separation provided by the insert has become less effective due to wear or damage.

15. The process according to claim 14, wherein the coating in step iii) is carried out by a reaction injection moulding (RIM) process.

16. The process according to claim 14, wherein the moulding of the substrate in step i) takes place by injection moulding, injection-compression moulding, compression moulding, or foaming or reaction injection moulding.

17. The process according to claim 14, wherein a reactive coating system is used which cures by a free-radical mechanism or ionic mechanism or by way of polyaddition.

18. The process according to claim 17, wherein the reactive coating system comprises a polyurethane system or a polyurea system.

19. The process according to claim 18, wherein the polyurethane system is a solvent-free aliphatic polyurethane system.
